(19) United States
(12) Patent Application Publication
(10) Pub. No.: US 2025/0110927 A1
(43) Pub. Date: Apr. 3, 2025

(54) FILE EXCHANGE APPARATUS, SYSTEM, METHOD, AND PROGRAM

(71) Applicant: NEC Corporation, Minato-ku, Tokyo (JP)

(72) Inventors: Hiroya OKADA, Tokyo (JP); Shinya Takeda, Tokyo (JP)

(73) Assignee: NEC Corporation, Minato-ku, Tokyo (JP)

(21) Appl. No.: 18/728,927

(22) PCT Filed: Jan. 31, 2022
(86) PCT No.: PCT/JP2022/003560

§ 371 Date: Jul. 15, 2024

(51) Int. Cl. G06F 16/182; G06F 16/13

(52) U.S. Cl. CPC G06F 16/183; G06F 16/137

(57) ABSTRACT

A file exchange apparatus includes: acquiring a label added file stored in a common use storage apparatus; isolating the acquired label added file from the common use storage apparatus and a plurality of dedicated use storage apparatuses; reading and identifying a label of the acquired label added file; and transmitting the acquired label added file to the dedicated use storage apparatus corresponding to the identified label.

### TECHNICAL FIELD

The present invention relates to a file exchange apparatus, a system, a method, and a program.

### BACKGROUND ART

In recent years, an air gap has been introduced for a purpose of protecting important information in system construction. The air gap is a technology that physically isolates (disconnects or shuts off) between a common use storage apparatus and a dedicated use storage apparatus by acquiring files stored in the common use storage apparatus that can be accessed from outside and storing the acquired files in the dedicated use storage apparatus that cannot be accessed from outside, using a file exchange apparatus. By using the air gap, it is possible to transfer files from the common use storage apparatus to the dedicated use storage apparatus without using a storage medium; block target type attacks on the dedicated use storage apparatus even if an attacker accesses from outside; and block communication between the outside attacker and the dedicated use storage apparatus even if malware infiltrates the dedicated use storage apparatus. Also, by using the air gap, it is possible to avoid a risk of losing a storage medium; protect data from leaking from the dedicated use storage apparatus by realizing the physical isolation; and synchronize time between physically separated networks.

As a technology that utilizes such an air gap, for example, there is a cyber retroreflector technology disclosed in Patent Literature (PTL) 1. In the cyber retroreflector technology of PTL 1, by an air gap within the device, a computing system performs physical and logical isolation between two electronic components.

### CITATION LIST

### Patent Literature

[PTL 1] JP2020-510901A

### SUMMARY

### Technical Problem

The following analysis is provided by the inventors.

Although the technology using the air gap is mainly used in government, military, finance, and other fields to prevent data from leaking, there are various demands depending on each field. As a typical demand, there is a demand to manage information separately for each department even within the same organization, for example, there is a demand to realize file management by using a configuration (one-to-multiple type configuration) that divides one common use storage apparatus into a plurality of dedicated use storage apparatuses.

However, the technology described in PTL 1 is configured to exchange files between two electronic components (one-to-one type configuration), and therefore cannot meet customer demands. Also, in a configuration in which one common use storage apparatus is simply divided into a plurality of dedicated use storage apparatuses, there is a possibility not to know if files stored in the common use storage apparatus ware stored in which of the plurality of dedicated use storage apparatuses stores and to cause a hindrance in file management between the common use storage apparatus and the plurality of dedicated use storage apparatuses.

It is a main object of the present invention to provide a file exchange apparatus, a system, a method, and a program that can contribute to avoid hindrances in file management even if one common use storage apparatus is divided into a plurality of dedicated use storage apparatuses.

### Solution to Problem

A file exchange apparatus according to a first aspect comprises: an air gap part configured to acquire a label added file stored in a common use storage apparatus, isolate the acquired label added file from the common use storage apparatus and a plurality of dedicated use storage apparatuses, and transmit the isolated label added file to any one of the plurality of dedicated use storage apparatuses; and a label identification part configured to read and identify a label of the label added file acquired by the air gap part, wherein the air gap part is configured to transmit the acquired label added file to the dedicated use storage apparatus corresponding to the label identified by the label identification part.

A file exchange system according to a second aspect comprises: a common use storage apparatus configured to be accessible from a common use network; a plurality of dedicated use storage apparatuses configured to be inaccessible from the common use network; and a file exchange apparatus according to the first aspect.

A file exchange method according to a third aspect is a file exchange method of exchanging files using hardware resources, and comprising: acquiring a label added file stored in a common use storage apparatus; isolating the acquired label added file from the common use storage apparatus and a plurality of dedicated use storage apparatuses; reading and identifying a label of the acquired label added file; and transmitting the acquired label added file to the dedicated use storage apparatus corresponding to the identified label.

A program according to a fourth aspect is a program that causes hardware resources to execute a process of exchanging files, wherein the program causes the hardware resources to execute processings: acquiring a label added file stored in a common use storage apparatus; isolating the acquired label added file from the common use storage apparatus and a plurality of dedicated use storage apparatuses; reading and identifying a label of the acquired label added file; and transmitting the acquired label added file to the dedicated use storage apparatus corresponding to the identified label.

The program can be recorded on a computer-readable storage medium. The storage medium may be a non-transitory such as a semiconductor memory, a hard disk, a magnetic recording medium, or an optical recording medium. Also, in the present disclosure, it is also possible to implement it as a computer program product. The program is input to a computer apparatus from an input device or from outside via a communication interface; is stored in a storage device; causes a processor to drive according to predetermined steps or processings; can cause to display processing results thereof, including an intermediate state via a display device step by step as necessary; or can cause to communicate with outside via a communication interface. The computer apparatus for that purpose typically comprises: for example, a processor; a storage device; an input device; a communication interface; and, if necessary, a display device, that can be connected to each other via a bus.

### Effects of Invention

According to the first to fourth aspects, it is possible to contribute to avoid hindrances in file management even if one common use storage apparatus is divided into a plurality of dedicated use storage apparatuses.

### BRIEF DESCRIPTION OF THE DRAWINGS

FIG. 1 is a block diagram schematically showing a configuration of a file exchange system according to an example embodiment 1.

FIG. 2 is a schematic diagram showing an example of a configuration of a label added file used in the file exchange system according to the example embodiment 1.

FIG. 3 is a flowchart schematically showing operations of the file exchange apparatus in the file exchange system according to the example embodiment 1.

FIG. 4 is a block diagram schematically showing a configuration of a file exchange system according to a comparative example.

FIG. 5 is a block diagram schematically showing the configuration of a file exchange system according to an example embodiment 2.

FIG. 6 is a block diagram schematically showing a configuration of a file exchange system according to an example embodiment 3.

FIG. 7 is a block diagram schematically showing a configuration of a file exchange system comprising a file exchange apparatus according to an example embodiment 4.

FIG. 8 is a block diagram schematically showing a configuration of hardware resources.

### EXAMPLE EMBODIMENTS

Hereinafter, example embodiments will be described with reference to drawings. It should be noted that when reference numerals are attached to the drawings in the present application, they are solely for a purpose of helping understanding, and are not intended to limit the example embodiments shown in the drawings. Also, the following example embodiments are only examples, and do not limit the present invention. Further, connection lines between blocks in the drawings and the like referred to in the following description include both bidirectional and unidirectional connections. The unidirectional arrows schematically show flows of main signals (data) and do not exclude bidirectionality. Furthermore, in circuit diagrams, block diagrams, internal configuration diagrams, connection diagrams, etc., disclosed in the present application, an input port and an output port exist at the input end and the output end of each connection line, respectively, although not explicitly shown. The same applies to input/output interface. The program is executed via a computer apparatus, and the computer apparatus comprises, for example, a processor, a storage device, an input apparatus, a communication interface, and a display apparatus as necessary. The computer apparatus is configured to be able to communicate with an internal or external apparatus (including computer) via the communication interface, irrespective of wired or wireless.

### Example Embodiment 1

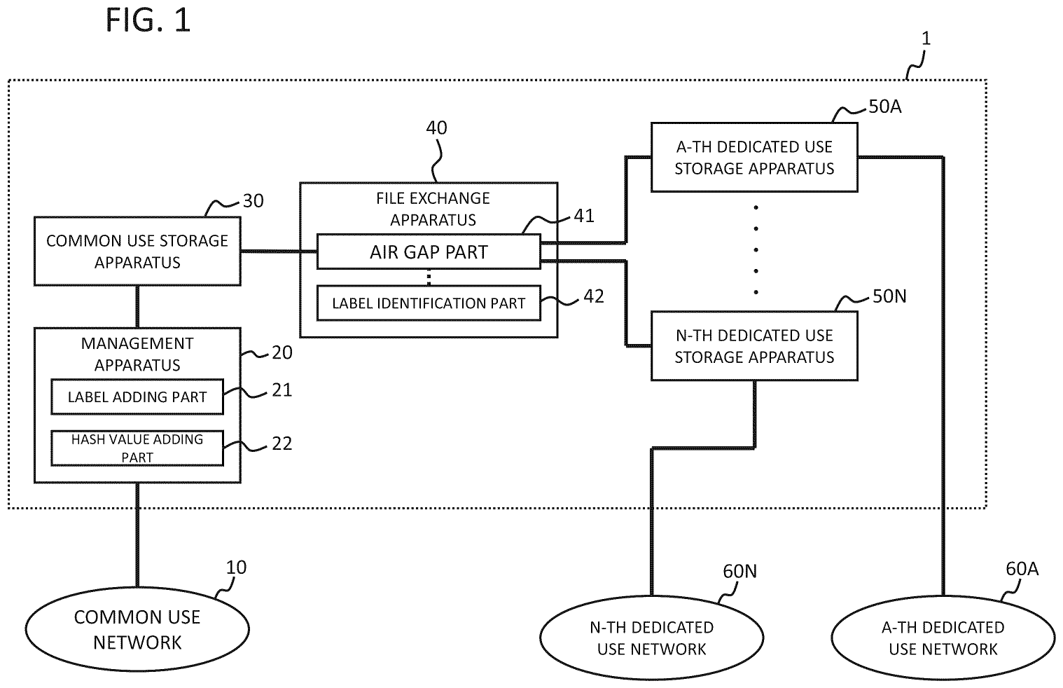

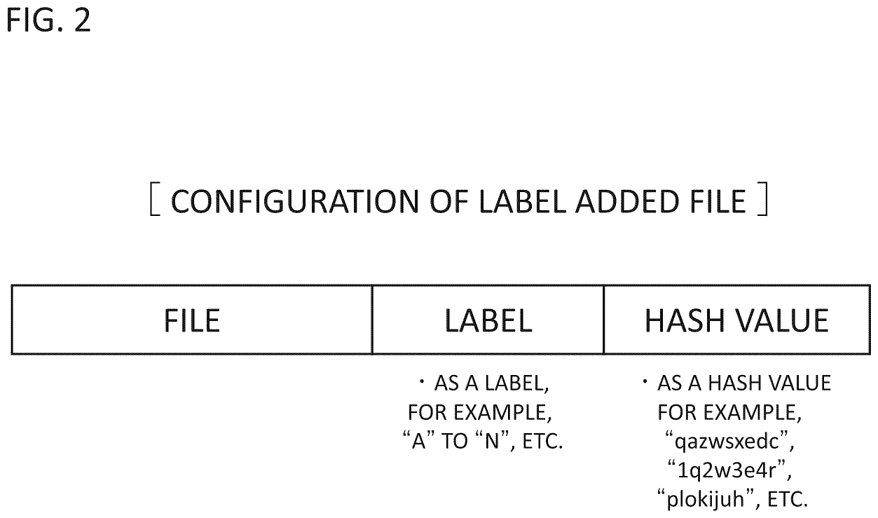

A file exchange system according to an example embodiment 1 will be explained using drawings. FIG. 1 is a block diagram schematically showing a configuration of a file exchange system according to the example embodiment 1. FIG. 2 is a schematic diagram showing an example of a configuration of a label added file used in the file exchange system according to the example embodiment 1.

The file exchange system 1 is a system that exchanges files between a common use storage apparatus 30 and a dedicated use storage apparatuses 50A to 50N (see FIG. 1). The file exchange system 1 is communicably connected to the common use network 10 and the dedicated use networks 60A to 60N. The file exchange system 1 comprises a management apparatus 20, the common use storage apparatus 30, a file exchange apparatus 40, and the dedicated use storage apparatuses 50A to 50N.

The management apparatus 20 is an apparatus that manages files stored in the common use storage apparatus 30 (see FIG. 1). The management apparatus 20 is communicably (wired-communicably, wireless-communicably) connected to the common use network 10 and the common use storage apparatus 30. The management apparatus 20 has a function of; acquiring a file from the common use network 10; adding a label and a hash value to the acquired file (file before being stored in the common use storage apparatus 30); and transmitting the label added file adding the label and the hash value to the common use storage apparatus 30 (see FIG. 2). As the management apparatus 20, for example, a computer including a processor, a memory, a network interface, etc. can be used. The management apparatus 20 can be virtually configured to comprise a label adding part 21 and a hash value adding part 22 by executing a program in a processor while using memory.

The label adding part 21 is a function part that adds a label to each file (label unadded file) stored in the common use storage apparatus 30 from the common use network 10 to create a label added file (see FIG. 1). In the example of FIG. 1, the label adding part 21 adds “A” to “N” as labels. Labels “A” to “N” are used to identify the corresponding dedicated use storage apparatuses 50A to 50N. The label adding part 21 may add labels “A” to “N” based on a predetermined criterion (for example, keywords included in the file, data amount, time point, etc.).

The hash value adding part 22 is a function part that adds a hash value to each file stored in the common use storage apparatus 30 from the common use network 10 (FIG. 1). The hash value adding part 22 calculates the hash value based on data included in a file (label unadded file or label added file) using a predetermined function (for example, a hash function, a summary function, a message digest function, etc.) set in advance and adds the calculated hash value to the corresponding file. As the hash values, for example, “qazwsxedc”, “1q2w3e4r”, “plokijuh”, and the like are listed. The hash value is used to determine an identity of file; the same hash value is always obtained from the same data, and if the data changes, the hash value will change, and the original data cannot be restored from the changed hash value.

The common use storage apparatus 30 is a storage apparatus that is used in common and can be accessed from the common use network 10 (see FIG. 1). The common use storage apparatus 30 stores the label added files (see FIG. 2) adding a label and a hash value by the management apparatus 20. The common use storage apparatus 30 is communicably connected to the management apparatus 20 and the file exchange apparatus 40. The common use storage apparatus 30 transmits the label added file to the file exchange apparatus 40 in response to a request from the file exchange apparatus 40.

The file exchange apparatus 40 is an apparatus that exchanges files between the common use storage apparatus 30 and the dedicated use storage apparatuses 50A to 50N (see FIG. 1). The file exchange apparatus 40 is communicably connected to the common use storage apparatus 30 and the dedicated use storage apparatuses 50A to 50N. The file exchange apparatus 40 has a function to physically isolate (disconnect, shut off) between the common use storage apparatus 30 and the dedicated use storage apparatuses 50A to 50N, and between the dedicated use storage apparatuses 50A to 50N by acquiring the label added file (see FIG. 2) stored in the common use storage apparatus 30 that is accessible from the common use network 10 and storing the acquired label added file in any one of the dedicated use storage apparatuses 50A to 50N that is inaccessible from the common use network 10. As the file exchange apparatus 40, for example, a computer including a processor, a memory, a network interface, etc. can be used. The file exchange apparatus 40 can be virtually configured to comprise an air gap part 41 and a label identification part 42 by executing a program in a processor while using a memory.

The air gap part 41 is a function part that acquires the label added file (see FIG. 2; file that has not been acquired in the past) stored in the common use storage apparatus 30; isolates (blocks) the acquired label added file from the common use storage apparatus 30 and the dedicated use storage apparatuses 50A to 50N; and then transmits the isolated label added file to any one of the dedicated use storage apparatuses 50A to 50N (see FIG. 1). Whether or not the label added file has been acquired in the past may be determined, for example, by whether or not the label added file is attached with a flag and may acquire the label added file without a flag by the air gap part 41 and then attach a flag to the label added file in the common use storage apparatus 30. The air gap part 41 causes the label identification part 42 to identify the label of the acquired label added file and transmits the acquired label added file to the dedicated use storage apparatuses 50A to 50N corresponding to the identified label. For example, the air gap part 41 transmits the label added file with label “A” to the A-th dedicated use storage apparatus 50A and transmits the label added file with label “N” to the N-th dedicated use storage apparatus 50N.

The label identification part 42 is a function part that reads and identifies the label of the label added file (see FIG. 2) acquired by the air gap part 41 (see FIG. 1). The label identification part 42 provides the identified label to the air gap part 41. The label identification part 42 is shown in order to clarify the label identification function, and may be incorporated into the air gap part 41 and integrated therewith.

The dedicated use storage apparatuses 50A to 50N are storage apparatuses that cannot be accessed from the common use network 10 (see FIG. 1). The dedicated use storage apparatuses 50A to 50N are communicably connected to the file exchange apparatus 40, and store label added files (see FIG. 2) sorted out by the file exchange apparatus 40 and adding a label and a hash value. The dedicated use storage apparatuses 50A to 50N are accessible from the corresponding dedicated use networks 60A to 60N. The dedicated use storage apparatuses 50A to 50N are isolated from each other.

The common use network 10 is a network used in common and provided to outside terminals (see FIG. 1). The common use network 10 is communicably connected to the management apparatus 20. As the common use network 10, for example, a communication network such as a PAN (Personal Area Network), a LAN (Local Area Network), a MAN (Metropolitan Area Network), a WAN (Wide Area Network), or a GAN (Global Area Network) can be used.

The dedicated use networks 60A to 60N are use networks used dedicatedly and provided only to the corresponding internal terminals (see FIG. 1). The dedicated use networks 60A to 60N are communicably connected to the corresponding dedicated use storage apparatuses 50A to 50N. As the dedicated use networks 60A to 60N, for example, a communication network such as a PAN or LAN that cannot be accessed by outsiders can be used. the dedicated use networks 60A to 60N are isolated from each other.

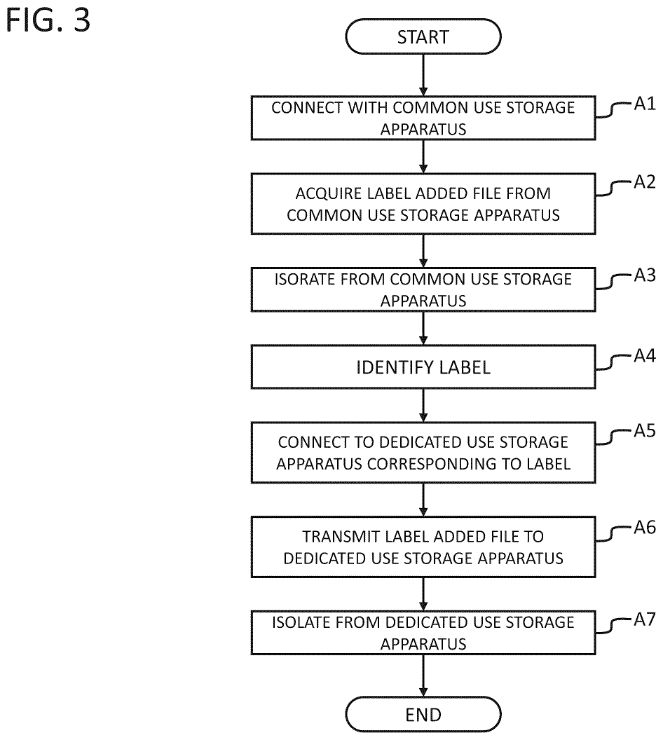

Operations of the file exchange apparatus in the file exchange system according to the example embodiment 1 will be explained using drawings. FIG. 3 is a flowchart schematically showing operations of the file exchange apparatus in the file exchange system according to the example embodiment 1. Please see FIG. 1 as to the configuration of the file exchange system.

Here, it is assumed that the common use storage apparatus 30 stores a label added file (see FIG. 2) adding a label and a hash value by the management apparatus 20.

First, the air gap part 41 of the file exchange apparatus 40 communicably connects with the common use storage apparatus 30 (step A1). At this time, the air gap part 41 cuts off communication with the dedicated use storage apparatuses 50A to 50N.

Next, the air gap part 41 acquires a label added file (file that has not been acquired in the past; see FIG. 2) from the common use storage apparatus 30 (step A2). At this time as well, the air gap part 41 cuts off communication with the dedicated use storage apparatuses 50A to 50N.

Next, the air gap part 41 cuts off communication with the common use storage apparatus 30 (step A3). At this time as well, the air gap part 41 cuts off communication with the dedicated use storage apparatuses 50A to 50N.

Next, the label identification part 42 of the file exchange apparatus 40 reads and identifies the label of the label added file (see FIG. 2) acquired by the air gap part 41 (step A4). At this time as well, the air gap part 41 cuts off communication with the common use storage apparatus 30 and the dedicated use storage apparatuses 50A to 50N.

Next, the air gap part 41 communicably connects with the dedicated use storage apparatus (for example, 50A) corresponding to the label identified by the label identification part 42 (step A5). At this time, the air gap part 41 cuts off communication with the common use storage apparatus 30 and the dedicated use storage apparatuses (for example, dedicated use storage apparatuses other than 50A) that do/does not correspond to the label identified by the label identification part 42.

Next, the air gap part 41 transmits the acquired label added file to the dedicated use storage apparatus (for example, 50A) corresponding to the label identified by the label identification part 42 (step A6). At this time as well, the air gap part 41 cuts off communication with the common use storage apparatus 30 and the dedicated use storage apparatuses (for example, dedicated use storage apparatuses other than 50A) that do/does not correspond to the label identified by the label identification part 42.

Finally, the air gap part 41 cuts off communication with the dedicated use storage apparatus (for example, 50A) corresponding to the label identified by the label identification part 42 (step A7), and then the process ends. At this time as well, the air gap part 41 cuts off communication with the common use storage apparatus 30 and the dedicated use storage apparatuses (for example, dedicated use storage apparatuses other than 50A) that do/does not correspond to the label identified by the label identification part 42.

According to the example embodiment 1, by having a function of identifying a label added to a file, it is possible to contribute to avoid hindrances in file management even if one common use storage apparatus is divided into the plurality of dedicated use storage apparatuses 50A to 50N. Accordingly, an operability of the system can be improved, and convenience can be improved while ensuring file security.

Also, according to the example embodiment 1, by adding a hash value to a file, since the hash value will not change unless the file contents are changed, it is possible to prove a validity of the file even in environments in which a network is not connected and a time point is different.

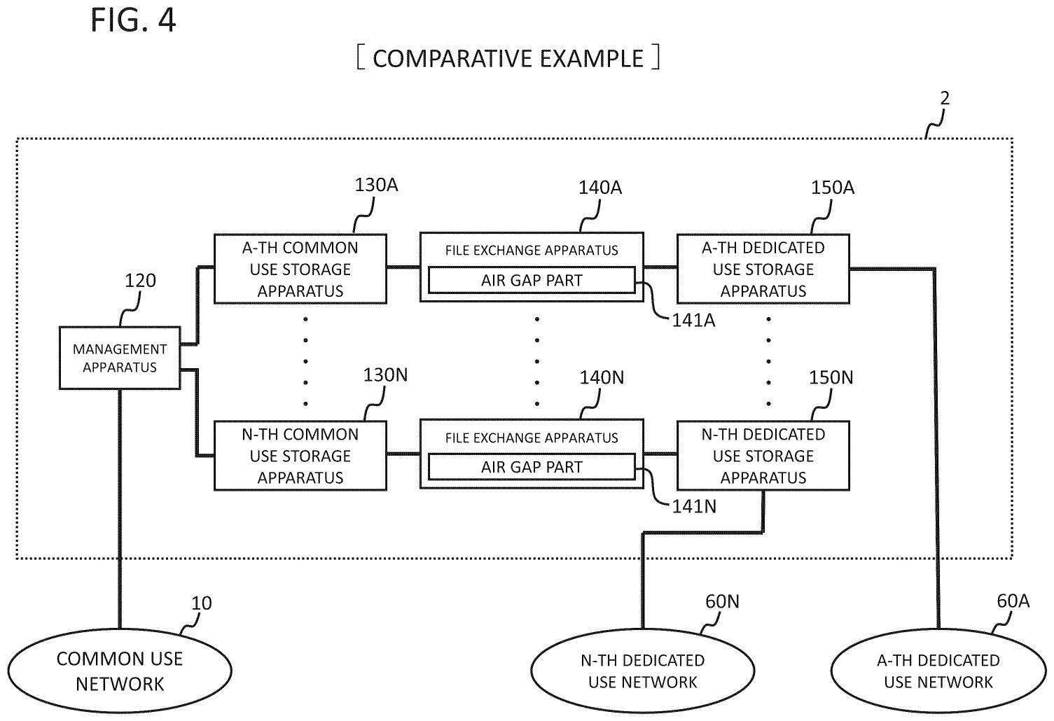

Further, according to the example embodiment 1, by having a function of attaching a label to a file to identify it, since there is no need to use multiple common use storage apparatuses 130A to 130N and multiple file exchange apparatuses 140A to 140N as shown in FIG. 4 (comparative example) and only one common use storage apparatus 30 and one file exchange apparatus 40 are enough, it is possible to reduce costs while reducing a complexity of the system configuration.

Furthermore, according to the example embodiment 1, by using a hash value as a data label, it is possible to serve as a timestamp and prove an authenticity of the file even if a time point is different between communicating networks.

### Example Embodiment 2

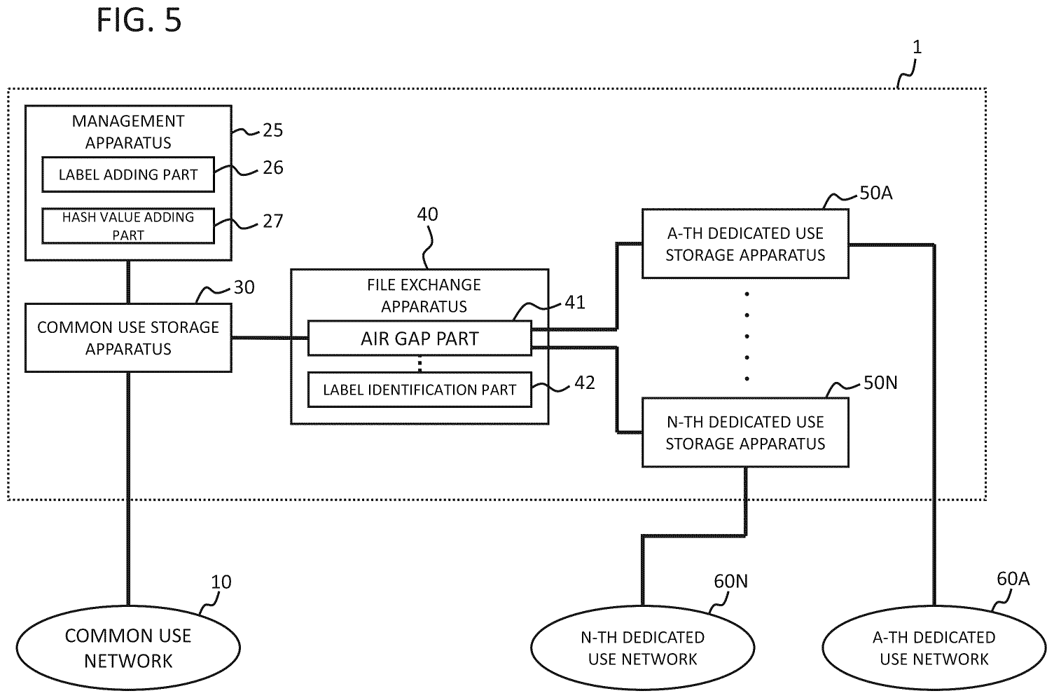

A file exchange system according to an example embodiment 2 will be explained using drawings. FIG. 5 is a block diagram schematically showing a configuration of the file exchange system according to the example embodiment 2.

The example embodiment 2 is a modification of the example embodiment 1. In the example embodiment 2, the common use network 10 is connected to the common use storage apparatus 30. The management apparatus 25 is connected to the common use storage apparatus 30 but not to the common use network 10. A timing at which a label and a hash value are added by the management apparatus 25 is not before storage in the common use storage apparatus 30, but at a predetermined or arbitrary timing after storage in the common use storage apparatus 30.

The management apparatus 25 is an apparatus that manages files stored in the common use storage apparatus 30 (see FIG. 5). The management apparatus 25 is communicably (wired-communicably, wireless-communicably) connected to the common use storage apparatus 30. The management apparatus 25 has a function of adding a label and a hash value to the file (file to which no label and hash value have been added) stored in the common use storage apparatus 30. As the management apparatus 25, for example, a computer including a processor, a memory, a network interface, etc. can be used. The management apparatus 25 can be configured to virtually comprise a label adding part 26 and a hash value adding part 27 by executing a program in a processor while using memory.

The label adding part 26 is a function part that adds a label to each file (label unadded file; file before adding a label) stored in the common use storage apparatus 30 to create a label added file (see FIG. 5). In the example of FIG. 5, the label adding part 26 adds “A” to “N” as a label. The labels “A” to “N” are used to identify the corresponding dedicated use storage apparatuses 50A to 50N. The label adding part 26 may add labels “A” to “N” based on a predetermined criterion (for example, keywords included in the file, data amount, time point, etc.) set in advance.

The hash value adding part 27 is a function part that adds a hash value to each file (file to which no hash value has been added) stored in the common use storage apparatus 30 (FIG. 5).

The hash value adding part 27 calculates a hash value based on the data included in the file (label unadded file or label added file) and adds the calculated hash value to the corresponding file using a predetermined function (for example, a hash function, a summary function, a message digest function, etc.) set in advance. As the hash value, for example, “qazwsxedc”, “1q2w3e4r”, “plokijuh”, and the like are listed. The hash value is used to determine an identity of files. The same hash value is always obtained from the same data. If the data changes, the hash value will change and the original data cannot be restored from the changed hash value.

Other configurations and operations are the same as the example embodiment 1.

According to the example embodiment 2, similarly to the example embodiment 1, by having a function of identifying a label added to files, it is possible to contribute to avoid hindrances in file management even if one common use storage apparatus is divided into the plurality of dedicated use storage apparatuses 50A to 50N.

### Example Embodiment 3

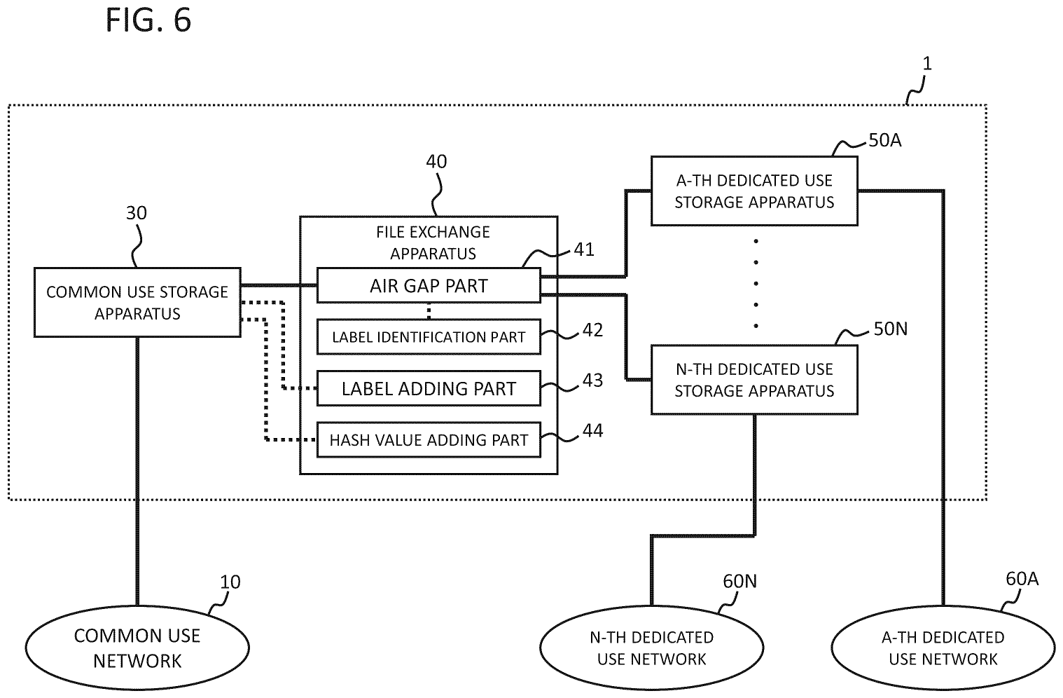

A file exchange system according to an example embodiment 3 will be explained using drawings. FIG. 6 is a block diagram schematically showing a configuration of a file exchange system according to the example embodiment 3.

The example embodiment 3 is a modification of the example embodiment 2. The example embodiment 3 is configured to build a function adding a label and a hash value to each file (file to which no label or hash value is added) stored in the common use storage apparatus 30 into the exchange apparatus 40.

The file exchange apparatus 40 is an apparatus that exchanges a file between the common use storage apparatus 30 and the dedicated use storage apparatuses 50A to 50N (see FIG. 6). The file exchange apparatus 40 is communicably connected to the common use storage apparatus 30 and the dedicated use storage apparatuses 50A to 50N. The file exchange apparatus 40 has a function of adding a label and a hash value to the file (file to which no label or hash value has been added) stored in the common use storage apparatus 30. The file exchange apparatus 40 has a function of physically isolating (disconnecting, shutting off) between the common use storage apparatus 30 and the dedicated use storage apparatuses 50A to 50N, and between the dedicated use storage apparatuses 50A to 50N by acquiring the label added file stored in the common use storage apparatus 30 that can access from the common use network 10 and storing the acquired label added file to any one of the dedicated use storage apparatuses 50A to 50N that can not access from the common use network 10. As the file exchange apparatus 40, for example, a computer including a processor, a memory, a network interface, etc. can be used. The file exchange apparatus 40 can be configured to virtually comprise an air gap part 41, a label identification part 42, a label adding part 43, a hash value adding part 44 by executing a program in a processor while using memory. It is possible to have a configuration with the following. The air gap part 41 and the label identification part 42 are the same as the air gap part (41 in FIG. 1) and the label identification part (42 in FIG. 1) of the example embodiment 1.

The label adding part 43 is a function part that adds a label to each file (label unadded file; file before adding a label) stored in the common use storage apparatus 30 to create a label added file (see FIG. 6). In the example of FIG. 6, the label adding part 43 adds “A” to “N” as a label. The Labels “A” to “N” are used to identify the corresponding dedicated use storage apparatuses 50A to 50N. The label adding part 43 may add labels “A” to “N” based on a predetermined criterion (for example, keywords included in the file, data amount, time point, etc.) set in advance.

The hash value adding part 44 is a function part that adds a hash value to each file (file to which no hash value has been added) stored in the common use storage apparatus 30 (FIG. 6). The hash value adding part 44 calculates a hash value based on the data included in the file (label unadded file or label added file) and adds the calculated hash value to the corresponding file using a predetermined function (for example, a hash function, a summary function, a message digest function, etc.) set in advance. As the hash value, for example, “qazwsxedc”, “1 q2w3e4r”, “plokijuh”, and the like are listed. The hash value is used to determine an identity of the file. The same hash value is always obtained from the same data. If the data changes, the hash value will change and the original data cannot be restored from the changed hash value.

Other configurations and operations are the same as the example embodiment 2.

According to the example embodiment 3, similarly to the example embodiment 2, by having a function of identifying a label added to files, it is possible to contribute to avoid hindrances in file management even if one common use storage apparatus 30 is divided into the plurality of dedicated use storage apparatuses 50A to 50N and simplify a system configuration.

### Example Embodiment 4

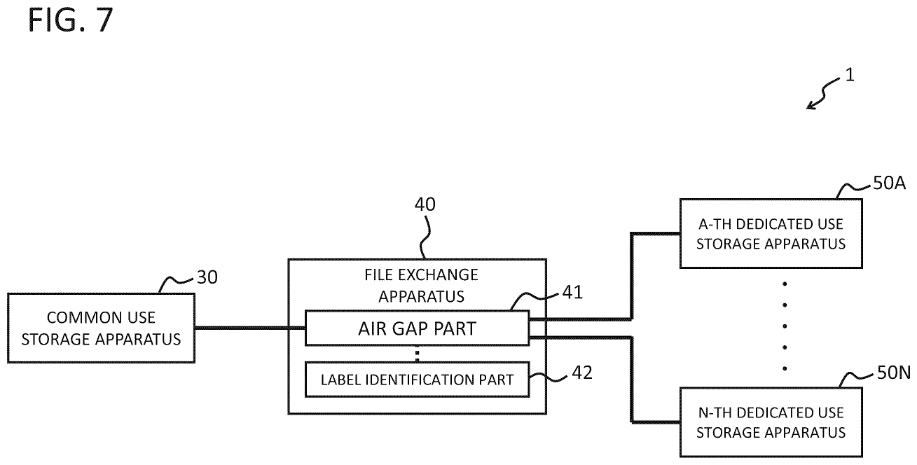

A file exchange apparatus according to an example embodiment 4 will be explained using drawings. FIG. 7 is a block diagram schematically showing a configuration of a file exchange system comprising the file exchange apparatus according to the example embodiment 4.

The file exchange system 1 is a system that comprises a file exchange apparatus 40 that exchanges files between a common use storage apparatus 30 and a plurality of dedicated use storage apparatuses 50A to 50N. The file exchange apparatus 40 comprises an air gap part 41 and a label identification part 42.

The air gap part 41 is configured to: acquire a label added file stored in a common use storage apparatus 30; isolate the acquired label added file from the common use storage apparatus 30 and a plurality of dedicated use storage apparatuses 50A to 50N; and transmit the isolated label added file to any one of the plurality of dedicated use storage apparatuses 50A to 50N. The air gap part 41 is configured to transmit the acquired label added file to a dedicated use storage apparatus (for example, 50A) corresponding to the label identified by the label identification part 42.

The label identification part 42 is configured to read and identify a label of the label added file acquired by the air gap part 41.

According to the example embodiment 4, by having a function of identifying a label of the label added file, it is possible to contribute to avoid hindrances in file management even if one common use storage apparatus is divided into the plurality of dedicated use storage apparatuses 50A to 50N.

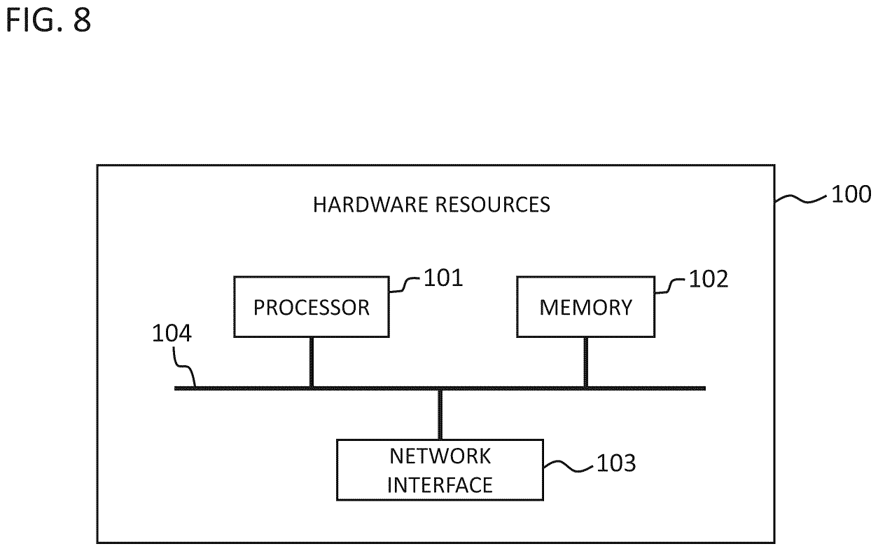

The file exchange apparatuses according to the example embodiments 1 to 4 and the management apparatuses according to the example embodiments 1 and 2 can be configured by so-called hardware resources (information processing apparatus, computer), and can use an apparatus comprising the configuration shown exemplarily in FIG. 8. For example, the hardware resources 100 comprise a processor 101, a memory 102, and a network interface 103, etc., which are interconnected by an internal bus 104.

The configuration shown in FIG. 8 is not intended to limit the hardware configuration of the hardware resources 100. The hardware resource 100 may include hardware (for example, an input/output interface) that is not shown. Alternatively, the number of units such as the processors 101 included in the apparatus is not limited to the example shown in FIG. 8; for example, a plurality of processors 101 may be included in the hardware resources 100. As the processor 101, for example, a CPU (Central Processing part), an MPU (Micro Processor Unit), a GPU (Graphics Processing part), etc. can be used.

As the memory 102, for example, RAM (Random Access Memory), ROM (Read Only Memory), HDD (Hard Disk Drive), SSD (Solid State Drive), etc. can be used.

As the network interface 103, for example, a LAN (Local Area Network) card, a network adapter, a network interface card, etc. can be used.

The functions of the hardware resources 100 are realized by the processing modules described above. The processing module is realized, for example, by the processor 101 executing a program stored in the memory 102. Also, the program can be updated by downloading over a network or by using a storage medium storing the program. Further, the processing module may be realized by a semiconductor chip. That is, the functions performed by the processing module may be able to be realized by executing software on some kind of hardware.

A part or all of the above example embodiments may be described as the following modes but is not limited to the following.

### [Mode 1]

A file exchange apparatus, comprising:
an air gap part configured to acquire a label added file stored in a common use storage apparatus, isolate the acquired label added file from the common use storage apparatus and a plurality of dedicated use storage apparatuses, and transmit the isolated label added file to any one of the plurality of dedicated use storage apparatuses; and a label identification part configured to read and identify a label of the label added file acquired by the air gap part,
wherein the air gap part is configured to transmit the acquired label added file to the dedicated use storage apparatus corresponding to the label identified by the label identification part.

### [Mode 2]

The file exchange apparatus according to Mode 1, further comprising a label adding part configured to create the label added file by adding a label to a label non-added file stored in the common use storage apparatus based on a predetermined criterion set in advance.

### [Mode 3]

The file exchange apparatus according to Mode 2, further comprising a hash value adding part configured to calculate a hash value based on data included in the label non-added file or the label added file using a predetermined function set in advance and add the calculated hash value to the label non-added file or the label added file.

### [Mode 4]

A file exchange system, comprising:
a common use storage apparatus configured to be accessible from a common use network;
a plurality of dedicated use storage apparatuses configured to be inaccessible from the common use network; and
a file exchange apparatus according to any one of Modes 1 to 3.

### [Mode 5]

The file exchange system according to Mode 4, further comprising a management apparatus configured to communicably connect to the common use network and the common use storage apparatus and manage files stored in the common use storage apparatus,
wherein the file exchange apparatus is the file exchange apparatus according to Mode 1, and
wherein the management apparatus comprises a label adding part configured to create the label added file by adding a label to a label non-added file stored in the common use storage apparatus from the common use network based on a predetermined criterion set in advance.

### [Mode 6]

The file exchange system according to Mode 5, further comprising a hash value adding part configured to calculate a hash value based on data included in the label non-added file or the label added file stored in the common use storage apparatus from the common use network using a predetermined function set in advance and add the calculated hash value to the label non-added file or the label added file.

### [Mode 7]

The file exchange system according to Mode 4, further comprising a management apparatus configured to communicably connect to the common use storage apparatus and manage files stored in the common use storage apparatus,
wherein the common use storage apparatus is communicably connected to the common use network,
wherein the file exchange apparatus is the file exchange apparatus according to Mode 1, and
wherein the management apparatus comprises a label adding part configured to create the label added file by adding a label to the label non-added file stored in the common use storage apparatus based on a predetermined criterion set in advance.

### [Mode 8]

The file exchange system according to Mode 7, further comprising a hash value adding part configured to calculate a hash value based on data included in the label non-added file or the label added file stored in the common use storage apparatus using a predetermined function set in advance and add the calculated hash value to the label non-added file or the label added file.

### [Mode 9]

A file exchange method of exchanging files using hardware resources, comprising:
acquiring a label added file stored in a common use storage apparatus; isolating the acquired label added file from the common use storage apparatus and a plurality of dedicated use storage apparatuses; reading and identifying a label of the acquired label added file; and transmitting the acquired label added file to the dedicated use storage apparatus corresponding to the identified label.

### [Mode 10]

A program, causing hardware resources to execute processing of exchanging files,
wherein the program causes the hardware resources to execute processings:
acquiring a label added file stored in a common use storage apparatus; isolating the acquired label added file from the common use storage apparatus and a plurality of dedicated use storage apparatuses;
reading and identifying a label of the acquired label added file; and
transmitting the acquired label added file to the dedicated use storage apparatus corresponding to the identified label.

It should be noted that each disclosure of the above PTL shall be incorporated and described herein by reference and can be used as a basis or a part of the present invention as necessary. Within a framework of the entire disclosure of the present invention (including claims and drawings), it is possible to modify or adjust the example embodiments or examples based on the basic technical idea thereof. Also, within the framework of entire disclosure of the present invention, various combinations or selections (non-selection if necessary) of various disclosed elements (including each element of each claim, each element of each example embodiment or example, each element of each drawing, etc.) is possible. That is, it goes without saying that the present invention includes various modifications and modifications that can be made by one skilled in the art in accordance with all disclosures including claims and drawings, and the technical concept. Further, as to the numerical values and numerical ranges described in the present application, it is considered that arbitrary intermediate values, lower numerical values, and small ranges are described even if not explicitly recited. Furthermore, it is also considered that a matter used to combine part or all of each of the disclosed matters of the above-cited documents with the matters described in this document as a part of the disclosure of the present invention, in accordance with the gist of the present invention, if necessary, is included in the disclosed matters of the present application.

### REFERENCE SIGNS LIST

1, 2 File exchange system
10 Common use network
20, 25, 120 Management apparatus
21, 26, 43 Label adding part
22, 27, 44 Hash value adding part
30, 130A to 130N Common use storage apparatus
40, 140A to 140N File exchange apparatus
41, 141A to 141N Air gap part
42 Label identification part
50A˜50N, 150A˜150N Dedicated use storage apparatus
60A˜60N Dedicated use network
100 Hardware resources
101 Processor
102 Memory
103 Network interface
104 Internal bus

What is claimed is:

1. A file exchange apparatus, comprising:
an air gap part configured to acquire a label added file stored in a common use storage apparatus, isolate the acquired label added file from the common use storage apparatus and a plurality of dedicated use storage apparatuses, and transmit the isolated label added file to any one of the plurality of dedicated use storage apparatuses; and
a label identification part configured to read and identify a label of the label added file acquired by the air gap part,
wherein the air gap part is configured to transmit the acquired label added file to the dedicated use storage apparatus corresponding to the label identified by the label identification part.

2. The file exchange apparatus according to claim 1, further comprising a label adding part configured to create the label added file by adding a label to a label non-added file stored in the common use storage apparatus based on a predetermined criterion set in advance.

3. The file exchange apparatus according to claim 2, further comprising a hash value adding part configured to calculate a hash value based on data included in the label non-added file or the label added file using a predetermined function set in advance and add the calculated hash value to the label non-added file or the label added file.

4. A file exchange system, comprising:
a common use storage apparatus configured to be accessible from a common use network;
a plurality of dedicated use storage apparatuses configured to be inaccessible from the common use network; and
a file exchange apparatus according to claim 1.

5. The file exchange system according to claim 4, further comprising a management apparatus configured to communicably connect to the common use network and the common use storage apparatus and manage files stored in the common use storage apparatus,
wherein the file exchange apparatus is the file exchange apparatus according to claim 1, and
wherein the management apparatus comprises a label adding part configured to create the label added file by adding a label to a label non-added file stored in the common use storage apparatus from the common use network based on a predetermined criterion set in advance.

6. The file exchange system according to claim 5, further comprising a hash value adding part configured to calculate a hash value based on data included in the label non-added file or the label added file stored in the common use storage apparatus from the common use network using a predetermined function set in advance and add the calculated hash value to the label non-added file or the label added file.

7. The file exchange system according to claim 4, further comprising a management apparatus configured to communicably connect to the common use storage apparatus and manage files stored in the common use storage apparatus,
wherein the common use storage apparatus is communicably connected to the common use network,
wherein the file exchange apparatus is the file exchange apparatus according to claim 1, and
wherein the management apparatus comprises a label adding part configured to create the label added file by adding a label to the label non-added file stored in the common use storage apparatus based on a predetermined criterion set in advance.

8. The file exchange system according to claim 7, further comprising a hash value adding part configured to calculate a hash value based on data included in the label non-added file or the label added file stored in the common use storage apparatus using a predetermined function set in advance and add the calculated hash value to the label non-added file or the label added file.

9. A file exchange method of exchanging files using hardware resources, comprising:
acquiring a label added file stored in a common use storage apparatus;
isolating the acquired label added file from the common use storage apparatus and a plurality of dedicated use storage apparatuses;
reading and identifying a label of the acquired label added file; and
transmitting the acquired label added file to the dedicated use storage apparatus corresponding to the identified label.

10. A non-transitory computer readable recording medium storing a program, causing hardware resources to execute processing of exchanging files,
wherein the program causes the hardware resources to execute:
acquiring a label added file stored in a common use storage apparatus;
isolating the acquired label added file from the common use storage apparatus and a plurality of dedicated use storage apparatuses;
reading and identifying a label of the acquired label added file; and
transmitting the acquired label added file to the dedicated use storage apparatus corresponding to the identified label.

11. The file exchange method according to claim 9, further comprising creating the label added file by adding a label to a label non-added file stored in the common use storage apparatus based on a predetermined criterion set in advance.

12. The file exchange method according to claim 11, further comprising calculating a hash value based on data included in the label non-added file or the label added file using a predetermined function set in advance and adding the calculated hash value to the label non-added file or the label added file.

13. The non-transitory computer readable recording medium according to claim 10,
wherein the program causes the hardware resources to execute further creating the label added file by adding a label to a label non-added file stored in the common use storage apparatus based on a predetermined criterion set in advance.

14. The non-transitory computer readable recording medium according to claim 13,
wherein the program causes the hardware resources to execute further calculating a hash value based on data included in the label non-added file or the label added file using a predetermined function set in advance and adding the calculated hash value to the label non-added file or the label added file.
